(19) United States
(12) Patent Application Publication
(10) Pub. No.: US 2012/0264854 A1
(43) Pub. Date: Oct. 18, 2012

(54) PROCESS FOR PRODUCING AQUEOUS DISPERSIONS OF ALIPHATIC POLYCARBONATES

(75) Inventors: JULIEN COURTOIS, Ludwigshafen (DE); Martin Schneele, Waldsee (DE); Willi Riegel, Waghausel (DE); Hubertus Kröner, Neustadt (DE)

(73) Assignee: BASF SE, Ludwigshafen (DE)

(21) Appl. No.: 13/446,729

(22) Filed: Apr. 13, 2012

Related U.S. Application Data
(60) Provisional application No. 61/475,726, filed on Apr. 15, 2011.

(51) Int. Cl. C08L 69/00; C08L 5/00

(52) U.S. Cl. 524/27; 524/612

(57) ABSTRACT

Processes for producing aqueous dispersions of aliphatic polycarbonates are described herein. A solution of the aliphatic polycarbonate in at least one aprotic, organic solvent comprising at least 50% by volume ethyl acetate based on the total amount of the organic solvent is provided. The aliphatic polycarbonate solution is emulsified in an aqueous emulsification medium in the presence of at least one surface-active substance to produce an aqueous emulsion of the aliphatic polycarbonate solution. The apriotic, organic solvent is removed from the emulsion by vaporization.

The present invention relates to a process for producing aqueous dispersions of aliphatic polycarbonates. The invention also relates to the aqueous polycarbonate dispersions which can be obtained by this process and their use.

Aliphatic polycarbonates such as polypropylene carbonate are of interest as biodegradable polymers for numerous applications. For many applications, aqueous dispersions of polyalkylene carbonates would be of interest. Unlike aqueous polymer dispersions whose polymer chains have a backbone made up of carbon atoms, aqueous dispersions of polyalkylene carbonates cannot be produced by an emulsion polymerization process. Rather, such polymers are generally prepared by polycondensation of aliphatic diols with phosgene or by polyaddition of aliphatic oxiranes onto CO₂ in the presence of suitable catalysts in a nonaqueous polymerization medium and are, after removal of the solvent, usually obtained as solids. To obtain aqueous dispersions, they would have to be dispersed in water. However, it has to be taken into account that in the case of polycarbonates there is a risk of a reduction in the molecular weight due to hydrolysis because of the hydrolysis-labile carbonate groups present in the polymer backbone.

In principle, a number of methods of dispersing thermoplastic polymers, including aliphatic polycarbonates and in particular polypropylene carbonate, in water are known.

Firstly, a melt of the thermoplastic polymer can be emulsified using high shear forces in the aqueous dispersion medium comprising surface-active substances and the emulsion can subsequently be cooled. Such processes are known, for example, from U.S. Pat. No. 4,320,041, DE 4115531, EP 1302502, EP 1514891 and WO 97/49762. This procedure can generally be employed only in the case of polymers having a sufficiently low melt viscosity. As an alternative, the melt viscosity can be reduced by additions, but this brings problems for many applications. In the case of polycarbonates, there is the great risk that a reduction in the molecular weight will occur as a result of hydrolysis of the carbonate groups in the polymer backbone due to the drastic processing conditions.

Secondly, a solution of the polymer in an organic, preferably water-miscible solvent can be mixed with the aqueous dispersion medium and the organic solvent can subsequently be removed again. Such processes are described, for example, in U.S. Pat. No. 3,238,173, U.S. Pat. No. 3,726,824 and WO 2007/074042. However, this procedure does not necessarily lead to stable polymer dispersions or may lead to dispersions having a very broad particle size distribution.

WO 2006/136555 discloses a process for producing aqueous polymer dispersions, in which the polymer, e.g. a polyalkylene carbonate, is dissolved in an organic solvent which is sparingly soluble in water, this solution is introduced into an aqueous medium comprising surface-active substances to give a raw emulsion having droplet sizes of >2 μm, the raw emulsion obtained is subsequently passed through a microporous membrane to form an oil-in-water emulsion having an average droplet diameter of <1000 nm and the solvent is subsequently removed. However, owing to the use of the microporous membrane, the process is comparatively complicated and the resulting solids contents of the dispersions are low.

The earlier international patent application PCT/EP 2011/054471 describes a process for producing aqueous dispersions of thermoplastic polymers which have a plurality of ester groups and/or carbonate groups in the polymer backbone, have an acid number of less than 5 mg KOH/g, in particular not more than 3 mg KOH/g and at 180° C. have a zero-shear viscosity η₀ (180° C.) of less than 60 Pa·s, in which the thermoplastic polymer is introduced into the aqueous dispersion medium by means of a mixing apparatus which has at least one rotor-stator mixer. However, in the case of polyalkylene carbonates, only dispersions having a low solids content and a comparatively large particle size of the dispersed polyalkylene carbonate particles can be produced by this process.

No process which reliably allows aqueous dispersions of polyalkylene carbonates, in particular aqueous dispersions of polyalkylene carbonates having a particle size of less than 1 μm (weight average) and/or a polymer content of at least 25% by weight and in particular at least 30% by weight, to be produced has been described hitherto.

It is therefore an object of the present invention to provide a reliable process for producing aqueous dispersions of aliphatic polyalkylene carbonates. In particular, the process should make it possible to achieve at least one of the following objects:
to convert polyalkylene carbonates and in particular polypropylene carbonates into an aqueous dispersion without a significant reduction in the molecular weight;
to produce aqueous dispersions of polyalkylene carbonates having a solids content of at least 30% by weight; and
to produce aqueous dispersions of polyalkylene carbonates in which the polymer particles have a weight average particle diameter below 1000 nm, in particular below 800 nm.

These and further objects are achieved by the process described here and in the following.

The present invention relates to a process for producing aqueous dispersions of aliphatic polycarbonates, in particular polypropylene carbonate, which comprises:
i. provision of a solution of the aliphatic polycarbonate in at least one aprotic, organic solvent which comprises at least 50% by volume, in particular at least 80% by volume and especially at least 90% by volume, based on the total amount of the organic solvent, of ethyl acetate and preferably comprises less than 10% by volume, in particular less than 5% by volume or less than 2% by volume, based on the total amount of solvent, of solvent constituents having a boiling point above 100° C. at atmospheric pressure;
ii. emulsification of the solution of the aliphatic polycarbonate provided in step i. in an aqueous emulsification medium in the presence of at least one surface-active substance to give an aqueous emulsion of the solution of the aliphatic polycarbonate;
iii. removal of the aprotic, organic solvent from the emulsion by vaporization.

The process of the invention has a number of advantages. Firstly, it makes it possible for aqueous dispersions of aliphatic polycarbonates to be produced in a simple and reliable way without complicated processes such as passing polymer/solvent/water emulsions through microporous membranes being necessary. In addition, the ethyl acetate used here for dissolving the aliphatic polycarbonate is relatively unproblematical from a toxicological point of view and thus represents a further advantage of the process of the invention. In addition, the process of the invention leads to no or no appreciable reduction in the molecular weight as would have been expected in principle because of the carbonate functions comprised in the polymer backbone of the aliphatic polycarbonates. In addition, the process of the invention makes it possible to produce low-viscosity dispersions having viscosities of 2 Pa·s (Brookfield, 20° C., determined in accordance with DIN EN ISO 2555) or less, with such viscosities also being able to be achieved at solids contents of 40% by weight or more.

Furthermore, the process of the invention makes it possible for the first time to produce aqueous dispersions of aliphatic polycarbonates, in particular of polypropylene carbonates, which have a polymer content of at least 25% by weight, in particular at least 30% by weight, e.g. from 25 to 60% by weight and in particular from 30 to 55% by weight, and in which the polymer particles have a weight average particle diameter below 1000 nm, in particular below 800 nm. Such aqueous polycarbonate dispersions are novel.

The present invention accordingly also provides aqueous dispersions of at least one aliphatic polycarbonate which have a polymer content of at least 25% by weight, in particular at least 30% by weight, e.g. from 25 to 60% by weight and in particular from 30 to 50% by weight, and in which the polycarbonate particles have a weight average particle diameter, determined by light scattering, of not more than 1000 nm, in particular not more than 800 nm.

The particle diameters or particle radii or particle sizes and also particle size distributions of the polycarbonate particles indicated here are particle diameters as can be determined by means of photon correlation spectroscopy (PCS), also known as quasielastic light scattering (QELS) or dynamic light scattering. The average particle diameters are the mean of the cumulated analysis (mean of fits). The “mean of fits” is an average intensity-weighted particle diameter in nm which corresponds to the weight average particle diameter. The measurement method is described in the standard ISO 13321. Methods for this purpose are also know to those skilled in the art from the relevant technical literature, for example from H. Wiese in D. Distler, Wässrige Polymerdispersionen, Wiley-VCH 1999, chapter 4.2.1, p. 40ff and references cited there and also H. Auweter, D. Horn, J. Colloid Interf. Sci. 105 (1985) 399, D. Lilge, D. Horn, Colloid Polym. Sci. 269 (1991) 704 or H. Wiese, D. Horn, J. Chem. Phys. 94 (1991) 6429. The particle diameters indicated here are values determined at 20° C. and 101.325 hPa on 0.001-1% strength by weight dispersions. The average particle diameter can also be determined by means of hydrodynamic chromatography (HDC) using a particle size distribution analyzer (PSDA, Varian Deutschland GmbH) with a cartridge type No. 2 (standard) at a wavelength of 254 nm (measurement temperature 23° C. and measurement time, for example, 480 seconds).

The polycarbonate dispersions which can be obtained according to the invention or by the process of the invention typically have a weight average particle diameter in the range from 100 to 1000 nm, frequently in the range from 120 to 800 nm and especially in the range from 150 to 600 nm.

According to the invention, the polymers to be dispersed are aliphatic polycarbonates, also referred to as polyalkylene carbonates, in particular polypropylene carbonates.

Aliphatic polycarbonates are polymers which are made up predominantly of repeating units of the formula I defined below. In addition, the polyalkylene carbonates can also have repeating units of the formula II:

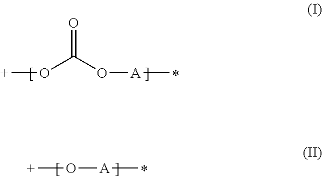

where A is an alkane-1,2-diyl radical having from 2 to 10 carbon atoms or a cycloalkane-1,2-diyl radical having 5 to 10 carbon atoms, where A can also have different meanings within one polymer. Symbols + and * indicate the binding sites to neighbored repeating units, where * is connected with + of the neighbored repeating unit and vice versa. A is preferably selected from alkane-1,2-diyl radicals, in particular those having from 2 to 4 carbon atoms, e.g. 1,2-ethanediyl, 1,2-propanediyl, 1,2-butanediyl, 1-methyl-1,2-propanediyl and 2-methyl-1,2-propanediyl. In a specific embodiment of the invention, A is predominantly, i.e. to an extent of at least 70 mol %, in particular at least 80 mol % or at least 90 mol %, based on all repeating units, 1,2-propanediyl. In this case, the aliphatic polycarbonate is polypropylene carbonate.

The proportion of carbonate repeating units of the formula I in the polycarbonate is dependent on the reaction conditions such as, in particular, the catalyst used. In preferred polycarbonates, more than 80 mol % and preferably more than 90% of all repeating units are units of the formula I.

Aliphatic polycarbonates are generally prepared by reacting aliphatic oxiranes, i.e. alkylene oxides, having generally from 2 to 10 carbon atoms or cycloalkylene oxides having generally from 5 to 10 carbon atoms with CO₂ in the presence of one or more suitable catalysts, see, for example, Inoue, Makromol. Chem., Rapid Commun. 1, 775 (1980), Soga et al., Polymer Journal, 1981, 13, 407-10, U.S. Pat. No. 4,789,727 and U.S. Pat. No. 7,304,172. Zinc and cobalt catalysts as described, for example, in the abovementioned literature and especially in U.S. Pat. No. 4,789,727 and U.S. Pat. No. 7,304,172 are particularly suitable.

Examples of suitable polyalkylene carbonates are the polyethylene carbonates which are known from EP-A 1264860 and are obtained by copolymerization of ethylene oxide and carbon dioxide in the presence of suitable catalysts and in particular polypropylene carbonate (see, for example, WO 2007/125039) which can be obtained by copolymerization of propylene oxide and carbon dioxide in the presence of suitable catalysts.

The polymer is also commercially available and is offered for sale by, for example, Empower Materials Inc. or Aldrich.

The number average molecular weight Mₙ of the polyalkylene carbonates, in particular the polypropylene carbonates, is generally from 5000 to 500 000 dalton, in particular from 10 000 to 250 000 dalton. The weight average molecular weight M_{w} is then usually in the range from 7000 to 5 000 000 dalton, in particular in the range from 15 000 to 2 000 000 dalton.

In a specific embodiment of the invention, the number average molecular weight Mₙ of the polypropylene carbonates is in the range from 50 000 to 100 000 dalton and especially in the range from 70 000 to 90 000 dalton. The weight average molecular weight M_{w} is then usually in the range from 100 000 to 500 000 dalton, in particular in the range from 150 000 to 400 000 dalton. The proportion of carbonate repeating units based on the total amount of carbonate and ether repeating units in the polymer is generally at least 80 mol %, in particular 90 mol %. The polydispersity (ratio of weight average (M_{w}) to number average (M_{N})) is generally in the range from 1 to 80 and preferably from 2 to 10. The polypropylene carbonates used can comprise up to 1% of carbamate and urea groups.

Suitable aliphatic polycarbonates also include chain-extended polyalkylene carbonates. Chain extenders used for the polyalkylene carbonates are, in particular, maleic anhydride, acetic anhydride, diisocyanates or polyisocyanates, dioxazolines or polyoxazolines or dioxazines or polyoxazines or diepoxides or polyepoxides. Examples of isocyanates are aromatic diisocyanates such as tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthalene 1,5-diisocyanate or xylylene diisocyanate and aliphatic diisocyanates, in particular hexamethylene 1,6-diisocyanate, isophorone diisocyanate or methylenebis(4-isocyanatocyclohexane). Particular preference is given to aliphatic diisocyanates and among these particularly isophorone diisocyanate and in particular hexamethylene 1,6-diisocyanate. As bisoxazolines, mention may be made of 2,2′-bis(2-oxazoline), bis(2-oxazolinyl)-methane, 1,2-bis(2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)-benzene or 1,3-bis(2-oxazolinyl)benzene. The chain extenders are preferably used in amounts of from 0.01 to 5% by weight, preferably from 0.05 to 2% by weight, particularly preferably from 0.08 to 1% by weight, based on the amount of polycarbonate. Chain-extended polyalkylene carbonates typically have a number average molecular weight Mₙ of from 30 000 to 500 000 dalton, preferably from 35 000 to 250 000 dalton and particularly preferably from 40 000 to 150 000 dalton.

Apart from the at least one aliphatic polycarbonate, the polymers to be dispersed can also comprise small amounts of other polymers selected, in particular, from among aliphatic or partially aromatic polyesters, aliphatic or partially aromatic polyesteramides, aliphatic or partially aromatic polyether esters and aliphatic or partially aromatic polyester carbonates. They include, in particular, polylactides, polycaprolactones, aliphatic and partially aromatic copolyesters, in particular aliphatic polyesters based on aliphatic dicarboxylic acids such as succinic acid, adipic acid, sebacic acid, azelaic acid, brassylic acid or mixtures thereof, with aliphatic diols such as ethanediol, 1,2- and 1,3-propanediol, 1,4-butanediol, neopentyl glycol, 1,6-hexanediol, diethylene glycol or mixtures thereof, and also partially aromatic copolyesters based on aliphatic dicarboxylic acids, in particular the abovementioned aliphatic dicarboxylic acids, with aromatic dicarboxylic acids, such as phthalic acid and/or terephthalic acid and aliphatic diols, in particular the abovementioned aliphatic diols. The proportion of the polymers other than aliphatic polycarbonates will in general be not more than 20% by weight, in particular not more than 10% by weight, based on the total amount of the polymers to be dispersed.

In step i. of the process of the invention, a solution of the aliphatic polycarbonate in at least one aprotic, organic solvent comprising at least 50% by volume, in particular at least 80% by volume and especially at least 90% by volume, based on the total amount of organic solvent used for dissolving the aliphatic polycarbonate, of ethyl acetate is provided. In other words, the content of ethyl acetate, based on the total volume of the organic solvent, is at least 50% by volume, in particular at least 80% by volume and especially at least 90% by volume. Apart from ethyl acetate, the solvent can also comprise aprotic solvents other than ethyl acetate. These further solvents are preferably selected so that they comprise less than 20% by volume, in particular less than 10% by volume or less than 2% by volume, based on the total amount of solvent, of solvents which have a boiling point above 100° C. at atmospheric pressure. Examples of suitable further aprotic organic solvents are methyl acetate, i-propyl acetate, methyl formate, ethyl formate, n-propyl formate, i-propyl formate, tetrahydrofuran, methyl ethyl ketone, dichloromethane and trichloromethane. The further organic solvents preferably do not comprise any halogenated organic solvents and are selected, in particular, from among the abovementioned esters of formic acid and of acetic acid.

The solution is generally provided by dissolving the polyalkylene carbonate in the aprotic organic solvent. Dissolution is typically carried out at temperatures in the range from 5 to 80° C., preferably in the range from 10 to 40° C. The solution provided in step i. can also be the product discharge from preparation of the polyalkylene carbonate from which catalysts and other impurities, e.g. the monomers used for the preparation, have preferably been removed.

The concentration of the aliphatic polycarbonate in the solution provided in step i. and used in step ii. is typically in the range from 5 to 50% by weight and in particular in the range from 5 to 40% by weight and especially in the range from 5 to 30% by weight, based on the total weight of the solution.

In step ii. of the process of the invention, the solution of the aliphatic polycarbonate provided in step i. is emulsified in an aqueous medium, which will hereinafter also be referred to as aqueous emulsification medium. Emulsification is, according to the invention, carried out in the presence of at least one surface-active substance.

For the purposes of the present invention, an aqueous emulsification medium is water or a mixture of water with small amounts of an organic solvent or solvent mixture which preferably has a boiling point at atmospheric pressure of less than 100° C. or with water forms an azeotrope having a boiling point at atmospheric pressure of less than 100° C. and which at atmospheric pressure and 20° C. is preferably miscible with water or has a miscibility of at least 50 g/l, in particular at least 100 g/l (at pH 6-8). The proportion of organic solvents in such mixtures will generally not exceed 20% by volume, in particular 10% by volume and especially 5% by volume. Examples of suitable organic solvents are C₁-C₄-alkanols, the abovementioned methyl and ethyl esters of formic acid and of acetic acid, tetrahydrofuran, acetone and methyl ethyl ketone.

According to the invention, the emulsification of the polyalkylene carbonate solution in the aqueous emulsification medium is carried out in the presence of at least one surface-active substance. In general, the surface-active substance is used in an amount of from 0.1 to 10% by weight, in particular in an amount of from 0.2 to 5% by weight, based on the amount of polyalkylene carbonate to be dispersed.

The at least one surface-active substance serves firstly to stabilize the emulsion produced in step ii. and also to stabilize the particles of the aliphatic polycarbonate in the aqueous dispersion of the aliphatic polycarbonate obtained in step iii.

Since the surface-active substances are, unlike the organic solvents used in step i., not volatile, they remain in the polymer dispersion and are therefore generally present in the aqueous dispersion of the aliphatic polycarbonate in an amount of from 0.1 to 10% by weight, in particular in an amount from 0.2 to 5% by weight, based on the aliphatic polycarbonate.

The surface-active substances can in principle be all surface-active substances which are fundamentally suitable for emulsification of organic solvents in water. They include essentially all emulsifiers and protective colloids suitable for this purpose, including mixtures thereof. Emulsifiers are generally low molecular weight or oligomeric substances which, unlike the polymeric protective colloids, have a (number average) molecular weight of not more than 2000 dalton, in particular not more than 1500 dalton. In contrast, protective colloids generally have a molecular weight above 2000 dalton (number average), e.g. in the range from 2200 to 10⁶ dalton.

The surface-active substances can in principle be nonionic, anionic, cationic or zwitterionic. The at least one surface-active substance is preferably selected from among anionic surface-active substances and nonionic surface-active substances and mixtures thereof.

Examples of protective colloids are water-soluble polymers such as:
neutral protective colloids: for example polyvinyl alcohols, including partially hydrolyzed polyvinyl acetate having a degree of hydrolysis of preferably at least 40%, in particular at least 60%, polyacrylamide, polyvinylpyrrolidone, poly-C₂-C₃-alkylene glycols, in particular polyethylene glycols, which are also referred to as poly(ethylene oxide) and poly(ethylene-co-propylene) glycols, which are also referred to as poly(ethylene oxide-co-propylene oxide), and among these especially poly(ethylene oxide-co-propylene oxide) triblock copolymers, also graft polymers of vinyl acetate and/or vinyl propionate on poly-C₂-C₃-alkylene glycols, poly-C₂-C₃-alkylene glycols capped at one or both ends with alkyl, carboxyl or amino end groups; and
anionic water-soluble polymers (anionic protective colloids) whose polymer backbone has a plurality of carboxyl groups, sulfonic acid groups or sulfonate groups and/or phosphonic acid groups or phosphonate groups, for example carboxymethylcellulose, homopolymers and copolymers of ethylenically unsaturated monomers which comprise at least 20% by weight, based on the total amount of monomers, of at least one ethylenically unsaturated monomer which has at least one copolymerized carboxyl group, sulfonic acid group and/or phosphonic acid group and salts thereof, in particular alkali metal and ammonium salts. In the abovementioned anionic water-soluble polymers, the sulfonic acid groups bound to the polymer backbone are usually present in salt form, i.e. as sulfonate groups, and the phosphonic acid groups are accordingly usually present at phosphonate groups in an aqueous medium. The counterions are then typically alkali metal and alkaline earth metal ions such as sodium ions, calcium ions and ammonium ions (NH₄⁺).

Nonionic emulsifiers which can be used are, for example, C₂-C₃-alkoxylated, in particular ethoxylated monoalkylphenols, dialkylphenols and trialkylphenols which generally have a degree of alkoxylation, in particular a degree of ethoxylation, in the range from 3 to 50, in particular from 5 to 30, and whose alkyl groups generally have a total of from 4 to 26 carbon atoms, and also C₂-C₃-alkoxylated, in particular ethoxylated, aliphatic alkanols having from 8 to 36 carbon atoms, in particular from 10 to 22 carbon atoms, and generally have a degree of alkoxylation, in particular a degree of ethoxylation, in the range from 3 to 50, in particular from 5 to 30. Examples are the Lutensol® A grades (C₁₂-C₁₄-fatty alcohol ethoxylates, degree of ethoxylation of from 3 to 50), Lutensol® AO grades (C₁₃-C₁₅-oxo alcohol ethoxylates, degree of ethoxylation of from 3 to 50), Lutensol® AT grades (C₁₆-C₁₈-fatty alcohol ethoxylates, degree of ethoxylation of from 11 to 80), Lutensol® ON grades (C₁₀-oxo alcohol ethoxylates, degree of ethoxylation of from 3 to 11) and Lutensol® TO grades (C₁₃-oxo alcohol ethoxylates, degree of ethoxylation of from 3 to 20) from BASF SE.

Customary anionic emulsifiers are the salts of amphiphilic substances which have at least one anionic functional group, e.g. at least one sulfonate, phosphonate, sulfate or phosphate group. These include, for example, the salts, in particular the alkali metal and ammonium salts, of sulfuric monoesters of aliphatic alcohols, in particular alkanols, generally having from 8 to 22 carbon atoms, the salts, in particular the alkali metal and ammonium salts, of amphiphilic compounds which have a sulfated or phosphated oligo-C₂-C₃-alkylene oxide group, in particular a sulfated or phosphated oligoethylene oxide group, for example the salts, in particular the alkali metal and ammonium salts, of sulfuric monoesters of ethoxylated aliphatic alcohols, in particular alkanols, generally having from 10 to 30 carbon atoms, in particular from 12 to 18 carbon atoms, and generally having a degree of ethoxylation in the range from 2 to 50, in particular from 4 to 30, the salts, in particular the alkali metal and ammonium salts, of sulfuric monoesters of ethoxylated alkylphenols whose alky radicals generally have from 4 to 12 carbon atoms and which generally have a degree of ethoxylation in the range from 2 to 50, the salts, in particular the alkali metal and ammonium salts, of phosphoric monoesters of ethoxylated aliphatic alcohols, in particular alkanols, generally having from 10 to 30 carbon atoms, in particular from 12 to 18 carbon atoms, and generally having a degree of ethoxylation in the range from 2 to 50, in particular from 4 to 30, the salts, in particular the alkali metal and ammonium salts, of phosphoric monoesters of ethoxylated alkylphenols whose alkyl radicals generally have from 4 to 12 carbon atoms and which generally have a degree of ethoxylation in the range from 2 to 50, the salts, in particular the alkali metal and ammonium salts, of alkylsulfonic acids, preferably having from 12 to 18 carbon atoms, the salts, in particular the alkali metal and ammonium salts, of alkylarylsulfonic acids (alkyl radical: C₄-C₁₈) and also the salts, in particular the alkali metal and ammonium salts, of alkylbiphenyl ether sulfonic acids (alkyl radical: C₄-C₁₈), e.g. the product sold under the trade name Dowfax® 2A1.

The surface-active substances is preferably selected from among the alkali metal salts, especially the sodium salts, of the abovementioned sulfuric monoesters of aliphatic alcohols, the alkali metal salts, especially the sodium salts, of the above-mentioned sulfuric monoesters of ethoxylated aliphatic alcohols, poly-C₂-C₃-alkylene oxides, preferably those having a number average molecular weight in the range from 2000 to 20 000 dalton, e.g. polyethylene oxide and poly(ethylene oxide-co-propylene oxide), in particular poly(ethylene oxide-co-propylene oxide) diblock and triblock copolymers and mixtures thereof, preferably those having a number average molecular weight in the range from 2000 to 20 000 dalton.

The surface-active substance can be added during emulsification and is preferably present in the aqueous dispersion medium or the polymer solution or in both.

Furthermore, it has been found to be advantageous for the aqueous emulsification medium to comprise one or more thickeners. For the purposes of the present invention, thickeners are substances which increase the viscosity of the aqueous emulsification medium. Preference is given to thickeners which are soluble in the aqueous emulsification medium. In particular, the thickeners are thickeners which give the aqueous dispersion medium non-Newtonian viscosity, i.e. a high viscosity at low shear rates of, for example, <10 sec⁻¹ and a low viscosity in the sheared state, e.g. at shear rates of >100 sec⁻¹.

In a preferred embodiment of the invention, the thickener is selected from among polysaccharide thickeners. These include modified celluloses and modified starches, in particular cellulose ethers such as methylcellulose, carboxymethylcellulose, hydroxyethylcellulose, hydroxypropylcellulose, methylhydroxypropylcellulose, methylhydroxyethylcellulose, natural polysaccharides such as xanthan, carrageenan, in particular κ-carrageenan, λ-carrageenan or t-carrageenan, alginates, guarana and agar and also modified xanthan such as succinylglycan or modified carrageenan. Preference is given to polysaccharide thickeners having anionic groups, e.g. carboxymethylcellulose, xanthan, modified xanthan, carrageenan, modified carrageenan and alginates and especially xanthan and modified xanthan, e.g. the xanthan products marketed under the trade names Kelzan® from Kelco and Rhodopol®, e.g. the Rhodopol® grades 23, 50MC, G, T and TG, from Rhodia.

The amount of thickener can be varied over a wide range and depends in a manner known per se on the desired viscosity and the type of thickener. The amount of thickener required to achieve the desired viscosity can be determined by a person skilled in the art in routine experiments. The concentration of thickener in the aqueous emulsification medium is typically in the range from 0.01 to 1% by weight, based on the total weight of the aqueous emulsification medium. The amount of thickener is preferably selected so that the aqueous emulsification medium or dispersion medium, respectively, has a viscosity at 20° C. and a shear rate of <10 sec⁻¹ in the range from 100 to 10 000 mPa·s, in particular in the range from 150 to 5000 mPa·s, determined in accordance with ISO 6721.

Emulsification of the solution of the polycarbonate in the aqueous emulsification medium can be carried out in a manner known per se by a method analogous to the usual methods of the prior art for emulsifying organic liquids which are immiscible or have only limited miscibility with water.

Suitable measures are, for example, methods in which energy is introduced by shearing into the mixture of aqueous emulsification medium and the solution of the polycarbonate in the organic medium. These include, for example, mixing using customary dynamic mixing devices such as stirrers, in particular stirrers which bring about effective shearing, dispersers, in particular gear dispersers or rotor-stator mixers, and also static mixers such as nozzles and mixing chambers into which the liquids to be mixed are introduced at high velocity. Preference is given to using shear rates of >1000 sec⁻¹, e.g. in the range from 1000 to 100 000 sec⁻¹, especially in the range from 5000 to 50 000 sec⁻¹, for emulsification.

For example, process step ii., i.e. the emulsification, can be carried out discontinuously by, for example shearing the solution of the polycarbonate and the aqueous emulsification medium, e.g. by stirring or by means of a suitable dispersing apparatus, in a vessel, in particular a mixing vessel, until a stable emulsion is obtained. As an alternative, a partial amount or the total amount of the polymer solution or of the aqueous emulsification medium can initially be placed in a vessel and the missing component can be added thereto while shearing.

Likewise, the emulsification can also be carried out continuously by introducing the polymer solution and the aqueous emulsification medium in the desired ratio simultaneously into a mixing zone and taking the emulsion from the mixing zone. Here, the mixing zone generally has dynamic and/or static mixing devices which effect shearing of the mixture during mixing of the polymer solution with the aqueous emulsification medium. Such a process is, for example, described in WO 00/33820.

Step ii is usually carried out at temperatures above the freezing point of the aqueous emulsification medium. To avoid premature vaporization of the organic solvent, step ii. is usually carried out at below the boiling point of the lowest-boiling component of the mixture, generally ethyl acetate or ethyl acetate/water azeotrope, under the emulsification conditions. Step ii. is typically carried out at temperatures of from >0° C. to 80° C., in particular in the range from 10 to 50° C. The pressure at which emulsification is carried out is generally of minor importance. In general, step ii is carried out at a pressure in the range from 900 mbar to 1500 mbar, but higher or lower pressures can also be employed.

In general, the solution of the aliphatic polycarbonate and the aqueous dispersion medium are emulsified in a weight ratio in the range from 20:1 to 1:10, in particular in a weight ratio in the range from 10:1 to 1:10 and especially in a weight ratio in the range from 10:1 to 1:5, in step ii.

This gives a stable emulsion of the solution of the aliphatic polycarbonate in the aqueous dispersion medium, with the aqueous emulsification medium generally forming the continuous phase and the polymer solution generally forming the discontinuous phase. However, an inverted phase arrangement can optionally also be present.

The organic solvent can subsequently be removed from the resulting aqueous emulsion by vaporization. Here, a partial amount of the water is generally also removed together with the organic solvent. The desired solids content can be set in this way. Water evaporated during step iii. can optionally also be replaced by fresh water or the vaporized mixture of water and solvent can be separated into water and organic solvent and the water can be partly or completely recirculated. The solvent obtained in this way can be recirculated to the production of further solutions of the aliphatic polycarbonate.

One or more antifoams can optionally be added to the aqueous emulsion before or during removal of the solvent in order to reduce foaming. It is likewise possible to add the antifoam to the aqueous emulsification medium at the beginning. Suitable antifoams are, in particular, those based on polysiloxanes and fatty alcohol mixtures.

Step iii. is typically carried out at temperatures of from 5° C. to 80° C., in particular in the range from 20 to 50° C. The removal of the organic solvent is preferably carried out under reduced pressure. The pressure at which step iii. is carried out naturally depends on the vapor pressure of the solvent/water mixture of the emulsion. The pressure will typically be in the range from 0.5 to 800 mbar, in particular in the range from 2 to 300 mbar. The pressure can be kept constant during removal of the organic solvent and optionally a partial amount of water. However, the pressure will generally be decreased during removal of the organic solvent. The lowering of the pressure can be carried out continuously or in one or more stages.

In general, the organic solvent will be removed to such an extent that the residual content of organic solvents, i.e. organic substances having a boiling point below 200° C. at atmospheric pressure, is not more than 1000 ppm, frequently not more than 500 ppm, in particular not more than 100 ppm. Further decreases in the amount of solvent can be achieved by further concentration or by dialysis or by a combination of these measures.

The aqueous dispersion of the aliphatic polycarbonate can subsequently be finished in a customary manner, for example by addition of microbicides.

The process of the invention makes it possible to produce stable aqueous dispersions of aliphatic polycarbonates, in particular polypropylene carbonates. The polymer contents are typically in the range from 10 to 60% by weight. However, the process is particularly suitable for producing stable concentrated dispersions of aliphatic polycarbonates, in particular polypropylene carbonates, which have a content of polycarbonate of at least 20% by weight, frequently at least 25% by weight and in particular at least 30% by weight, e.g. from 10 to 65% by weight, frequently from 20 to 60% by weight, preferably from 25 to 60% by weight and in particular from 30 to 50% by weight.

The inventive aqueous dispersions of aliphatic polycarbonates have, even at high solids contents, at least under shear, a low viscosity which is generally not more than 2000 mPa·s and in particular not more than 1000 mPa·s at 20° C. and a shear rate of >100 sec⁻¹. The inventive aqueous dispersions of aliphatic polycarbonates can, depending on whether they comprise a thickener, in particular a polysaccharide thickener, have non-Newtonian viscosity, in particular be thixotropic. The inventive aqueous dispersions of aliphatic polycarbonates are stable to sedimentation, even under freeze-thaw conditions.

Unlike the dispersions of the prior art, low-viscosity dispersions can be produced, even at high polymer contents, by means of the process of the invention. The viscosity of the dispersions which can be obtained according to the invention is, as determined by the Brookfield method at 20° C., preferably not more than 2 Pa·s, frequently not more than 1 Pa·s, e.g. in the range from 1 to 2000 mPa·s, in particular in the range from 10 to 1000 mPa·s.

The polymer dispersions which can be obtained by the process of the invention and the polymer dispersions of the invention are suitable for many applications which are customary for aqueous polymer dispersions. The polymer dispersions which can be obtained by the process of the invention and the inventive aqueous dispersions of aliphatic polycarbonates, in particular those in which the polycarbonate is a polypropylene carbonate, are particularly suitable for applications in which biodegradability of the polymer constituent is desirable. In particular, the aqueous dispersions are suitable as binder constituent in aqueous binder compositions, in particular for binder compositions for paper manufacture, e.g. as size for paper, as internal size or as agent for surface sizing, as strengthening agent for paper, as binder for paper coating and as binder in pigment-free coating compositions, for the production of barrier coatings on paper, paperboard or card, as binder for pigment-comprising coating compositions such as paints for interior and exterior applications, also in binder compositions for fiber bonding and for the production of nonwovens. In addition, the aqueous dispersions are suitable for use in adhesives, for example as laminating adhesives, especially as laminating adhesives for laminating polymer films onto flat supports such as paper, paperboard, card or polymer films or for formulating active compounds in the agrochemicals sector or in pharmacy. The polymer dispersions of the invention can also be used for producing film materials.

The invention is illustrated below with the aid of examples.

### Analysis

The determination of the viscosity of the emulsification medium was carried out by a method based on DIN EN ISO 6721 using a Physika MCR rotational viscometer with double gap geometry DG 26.7, at shear rates of 0.1 to 10 sec⁻¹ and a measurement temperature of 20° C.

The particle size distribution was determined on an about 0.02% strength by weight dilution of the dispersion by light scattering at 23° C. using a Mastersizer from Malvern. The determination of the average particle diameter can also be carried out by means of hydrodynamic chromatography (HDC) using a Particle Size Distribution Analyser (PSDA, Varian Deutschland GmbH) with a cartridge type No. 2 (standard) at a wavelength of 254 nm (measurement temperature 23° C. and measurement time 480 seconds).

The determination of the viscosity of the dispersions was carried out at 20° C. using a method based on DIN EN ISO 6721 and using a rotation viscometer (Physika MCR double gap geometry DG 26.7) at a shear rate of 10 sec⁻¹.

The determination of the solids content is carried out by means of a Halogen Moisture Analyser from Mettler-Toledo.

The determination of the residual concentration of solvent is carried out by means of gas chromatography.

### Starting Materials:

A polypropylene carbonate (hereinafter PPC) having a number average molecular weight of 80 000 dalton and a weight average molecular weight of 250 000 dalton was used for the following experiments.

The following surface-active substances were used:

emulsifier solution 1: aqueous 27% strength by weight solution of ethoxylated lauryl sulfate, Na salt (Hansanol® NS 242 from HANSA Group AG)
emulsifier solution 2: aqueous 57% strength by weight solution of amine salt of laurylbenzylsulfonate (Lutensit® A-LBA from BASF SE)
protective colloid 1: poly(ethylene oxide-co-propylene oxide) triblock copolymer (Pluronic PE 6800 from BASF SE)
thickener: xanthan (Xanthan Gum from SigmaAldrich Chemie GmbH)
antifoam: 10% strength by weight aqueous emulsion of a silicone-based antifoam (Tego® Foamex from Evonik Tego GmbH)

### Production of the Aqueous Polycarbonate Dispersions

### EXAMPLE 1

0.56 g of emulsifier solution 1 (corresponding to 1.3% by weight of emulsifier, based on PPC) was added to 100 g of a 10% strength by weight solution of PPC in ethyl acetate. 66 g of a 0.25% strength by weight solution of xanthan in water (viscosity 127 mPas at 20° C. and a shear rate of 10 sec⁻¹) were added thereto at 20° C. and the mixture was dispersed by means of an Ultraturrax at 24 000 rpm until a stable emulsion was obtained (about 55 sec). 0.2% by weight of the antifoam was added thereto and the organic solvent and a partial amount of the water was removed at 35° C. under reduced pressure (from 300 to 70 mbar) by means of a rotary evaporator. This gave an aqueous dispersion of PPC having a polymer content of 34.2% by weight. The average particle diameter determined by means of HDC was 450 nm.

### EXAMPLE 2

0.53 g of emulsifier solution 2 (corresponding to 3% by weight of emulsifier, based on PPC) was added to 100 g of a 10% strength by weight solution of PPC in ethyl acetate. 66 g of a 0.2% strength by weight solution of xanthan in water were added thereto at 20° C. and the mixture was dispersed by means of an Ultraturrax at 24 000 rpm until a stable emulsion was obtained (about 55 sec). 0.2% by weight of the antifoam was added thereto and the organic solvent and a partial amount of the water was removed at 35° C. under reduced pressure (from 300 to 70 mbar) by means of a rotary evaporator. This gave an aqueous dispersion of PPC having a polymer content of 21.2% by weight. The average particle diameter determined by means of HDC was 400 nm.

### EXAMPLE 3

2.48 g of protective colloid 1 (corresponding to 24.8% by weight of protective colloid, based on PPC) was added to 100 g of a 10% strength by weight solution of PPC in ethyl acetate. 72 g of a 0.15% strength by weight solution of xanthan in water were added thereto at 20° C. and the mixture was dispersed by means of an Ultraturrax at 24 000 rpm until a stable emulsion was obtained (about 55 sec). 0.14% by weight of the antifoam was added thereto and the organic solvent and a partial amount of the water was removed at 35° C. under reduced pressure (from 300 to 70 mbar) by means of a rotary evaporator. This gave an aqueous dispersion of PPC having a polymer content of 34.8% by weight. The average particle diameter determined by means of HDC was 192 nm.

The dispersions of the examples 4, 4a, 5, 5a, 6, 6a and 6b were produced in a manner analogous to examples 1 to 3. The method of production, solids content, the viscosity and the particle size are shown in table 1 below.

TABLE 1

| | Method | Solids content | Viscosity at | D ¹⁾ | D ²⁾ |
|---|---|---|---|---|---|
| Example | Example | [% by weight] | 10 sec⁻¹ [mPa · s] | [nm] | [nm] |
| 4 | 1 | 33.9 | 765 | 450 | 340 |
| 4a | 1 | 41.5 | 1360 | 450 | 360 |
| 5 | 2 | 29.1 | 752 | 403 | 220 |
| 5a | 2 | 38.0 | 1200 | 406 | 330 |
| 6 | 3 | 29.7 | 225 | 260 | 380 |
| 6a | 3 | 40.1 | 520 | n.d. | n.d. |
| 6b | 3 | 51.1 | 1100 | n.d. | n.d. |

¹⁾ D₅₀ determined by means of HDC
²⁾ D₅₀ determined by means of dynamic light scattering

### EXAMPLES 7, 7A AND 7B

### General Method

1.84 g of emulsifier solution 1 (corresponding to 2.0% by weight of emulsifier, based on PPC) were added to 250 g of a 10% strength by weight solution of PPC in ethyl acetate and the mixture was homogenized by means of an Ultraturrax. 140 g of a 0.25% strength by weight solution of xanthan in water comprising 0.6% by weight of antifoam were added thereto at 20° C. and the mixture was dispersed at 20° C. by means of an Ultraturrax for about 1 min at 24 000 rpm until a stable emulsion had been obtained. The organic solvent was subsequently removed at 33° C. under a reduced pressure of 150 mbar by means of a rotary evaporator and the pressure was subsequently reduced to 30 mbar to remove further water. This gave an aqueous dispersion of PPC. The properties are shown in table 2 below.

TABLE 2

| | Solids content | Particle size distribution (HDC) | | |
|---|---|---|---|---|
| Example | [% by weight] | D₁₀ [nm] | D₅₀ [nm] | D₉₀ [nm] |
| 7 | 45.0 | 270 | 382 | 482 |
| 7a | 49.5 | 282 | 382 | 473 |
| 7b | 54.7 | 286 | 409 | 517 |

### EXAMPLE 8

0.92 g of emulsifier solution 1 (corresponding to 2% by weight of emulsifier, based on PPC) was added to 125 g of a 10% strength by weight solution of PPC in ethyl acetate, the mixture was homogenized by means of an Ultraturrax and heated to 60° C. 70 g of a 0.25% strength by weight solution of xanthan in water comprising 0.4 g of antifoam were added thereto at 60° C. and the mixture was dispersed by means of an Ultraturrax for about 55 sec at 24 000 rpm until a stable emulsion had been obtained. The organic solvent was subsequently removed at 33° C. under a reduced pressure of 240 mbar by means of a rotary evaporator and the pressure was subsequently reduced to 12 mbar to remove further water. This gave an aqueous dispersion of PPC. The properties are shown in table 3 below.

### EXAMPLE 9

An aqueous emulsification medium was produced by adding 0.4 g of antifoam and 0.92 g of emulsifier solution 1 (corresponding to 2% by weight of emulsifier, based on PPC) to 70 g of a 0.25% strength by weight solution of xanthan in water. 125 g of a 10% strength by weight solution of PPC in ethyl acetate was heated to 60° C. and the emulsification medium which had been heated to 60° C. was added thereto over a period of 30 minutes with the Ultraturrax running (24 000 rpm) and the mixture was dispersed for a further 55 sec by means of an Ultraturrax at 24 000 rpm until a stable emulsion had been obtained. The organic solvent was subsequently removed at 33° C. under a reduced pressure of 240 mbar by means of a rotary evaporator and the pressure was subsequently reduced to 12 mbar to remove further water. This gave an aqueous dispersion of PPC. The properties are shown in table 3.

TABLE 3

| | Solids content | Particle size distribution (light scattering) | | |
|---|---|---|---|---|
| Example | [% by weight] | D₁₀ [nm] | D₅₀ [nm] | D₉₀ [nm] |
| 8 | 23.4 | 220 | 320 | 510 |
| 9 | 22.2 | 210 | 320 | 560 |

### EXAMPLES 10, 10A AND COMPARATIVE EXAMPLES 11, 11A

### General Method

4.6 g of emulsifier solution 1 (corresponding to 5.0% by weight of emulsifier, based on PPC) were added to 150 g of a 10% strength by weight solution of PPC in the respective solvent (ethyl acetate in example 10, 10a, dichloromethane in comparative example 11, 11a) and the mixture was homogenized by means of an Ultraturrax. 140 g of a 0.25% strength by weight solution of xanthan in water comprising 0.8 g of antifoam were added thereto at 20° C. and the mixture was dispersed at 20° C. by means of an Ultraturrax for about 55 sec at 24 000 rpm until a stable emulsion had been obtained. The organic solvent was subsequently removed at 33° C. under a reduced pressure of 240 mbar by means of a rotary evaporator and the pressure was subsequently reduced to 12 mbar to remove further water. This gave an aqueous dispersion of PPC. The properties are shown in table 4 below.

TABLE 4

| | Solids | Residual | | | |
|---|---|---|---|---|---|
| | content | solvent | Particle size distribution | | |
| | [% by | content | (light scattering) | | |
| Example | weight] | [ppm] | D₁₀ [nm] | D₅₀ [nm] | D₉₀ [nm] |
| 10 | 30.9 | <10 | 190 | 290 | 440 |
| 10a | 31.4 | 15 | 240 | 370 | 660 |
| C11 | 26.3 | <10 | 940 | 2230 | 7600 |
| C11a | 32.1 | 10 | 870 | 1600 | 3220 |

1. A process for producing aqueous dispersions of aliphatic polycarbonates, which comprises
i. provision of a solution of the aliphatic polycarbonate in at least one aprotic, organic solvent which comprises at least 50% by volume, in particular at least 80% by volume, based on the total amount of the organic solvent, of ethyl acetate;
ii. emulsification of the solution of the aliphatic polycarbonate provided in step i. in an aqueous emulsification medium in the presence of at least one surface-active substance to give an aqueous emulsion of the solution of the aliphatic polycarbonate;
iii. removal of the aprotic, organic solvent from the emulsion by vaporization.

2. The process according to claim 1, wherein the concentration of the aliphatic polycarbonate in the solution used in step ii. is in the range from 5 to 50% by weight.

3. The process according to claim 1, wherein the surface-active substance is selected from among anionic surface-active substances and nonionic surface-active substances.

4. The process according to claim 3, wherein the surface-active substance is selected from among the alkali metal salts of sulfuric monoesters of aliphatic alcohols, the alkali metal salts of sulfuric monoesters of ethoxylated aliphatic alcohols, poly(ethylene oxide-co-propylene oxide) and mixtures thereof.

5. The process according to claim 1, wherein the surface-active substance is used in an amount of from 0.1 to 10% by weight, based on the aliphatic polycarbonate.

6. The process according to claim 1, wherein the aqueous dispersion medium comprises at least one thickener.

7. The process according to claim 6, wherein the thickener comprises at least one polysaccharide.

8. The process according to claim 1, wherein the aqueous dispersion medium has a viscosity at 20° C. in the range from 100 to 10 000 mPa·s, determined in accordance with ISO 6721 at a shear rate of <10 sec⁻¹.

9. The process according to claim 1, wherein emulsification in step ii. is effected by mixing the solution of the aliphatic polycarbonate with the aqueous emulsification medium with shearing.

10. The process according to claim 9, wherein shear rates of >1000 sec⁻¹ are employed.

11. The process according to claim 1, wherein step ii. is carried out at a temperature in the range from >0 to 80° C.

12. The process according to claim 1, wherein the solution of the aliphatic polycarbonate and the aqueous dispersion medium are emulsified in a weight ratio in the range from 20:1 to 1:10 in step ii.

13. The process according to claim 1, wherein the aliphatic polycarbonate is a polypropylene carbonate.

14. The process according to claim 1, wherein the aliphatic polycarbonate has a number average molecular weight in the range from 5000 to 500 000 dalton.

15. The process according to claim 1, wherein step iii. is carried out at a temperature in the range from 5 to 80° C.

16. An aqueous dispersion of at least one aliphatic polycarbonate, which has a polymer content of at least 25% by weight and in which the polycarbonate particles have a weight average particle diameter determined by light scattering of not more than 1000 nm.

17. The aqueous dispersion according to claim 16, wherein the aliphatic polycarbonate is a polypropylene carbonate.

18. The aqueous dispersion according to claim 16, wherein the aliphatic polycarbonate has a number average molecular weight in the range from 5000 to 500 000 dalton.

19. The aqueous dispersion according to claim 16 having a viscosity of not more than 2000 mPa·s at 20° C. and a shear rate of >100 sec⁻¹.

20. A method of producing a binder comprising utilizing the aqueous polymer dispersion according to claim 16 as binder in coating compositions, as size for paper, as paper strengthener, as binder compositions for nonwovens, in adhesives, for producing barrier coatings or for the formulation of active compounds.
